(19) United States
(12) Patent Application Publication
(10) Pub. No.: US 2024/0256868 A1
(43) Pub. Date: Aug. 1, 2024

(54) MACHINE-LEARNING BASED STABILIZATION CONTROLLER THAT CAN LEARN ON AN UNSTABLE SYSTEM

(71) Applicant: THE REGENTS OF THE UNIVERSITY OF CALIFORNIA, Oakland, CA (US)

(72) Inventors: Dan Wang, Berkeley, CA (US); Qiang Du, Pleasanton, CA (US); Russell Wilcox, Berkeley, CA (US); Tong Zhou, Albany, CA (US); Christos Bakalis, Berkeley, CA (US); Derun Li, Concord, CA (US)

(73) Assignee: THE REGENTS OF THE UNIVERSITY OF CALIFORNIA, Oakland, CA (US)

(21) Appl. No.: 18/607,954

(22) Filed: Mar. 18, 2024

Related U.S. Application Data
(63) Continuation of application No. PCT/US2022/045236, filed on Sep. 29, 2022.
(60) Provisional application No. 63/251,346, filed on Oct. 1, 2021.

(51) Int. Cl. G06N 3/08

(52) U.S. Cl. CPC G06N 3/08

(57) ABSTRACT

A machine learning (ML) controller and method for systems that can learn to stabilize them based on measurements of an unstable system. This allows for training on a system not yet controlled and for continuous learning as the stabilizer operates. The controller has improved performance on unstable systems compared to similar technologies, especially complex ones with many inputs and outputs. Furthermore, there is no need for modelling the physics, and the controller can adapt to un-analyzed or partially analyzed systems.

### CROSS-REFERENCE TO RELATED APPLICATIONS

This application claims priority to, and is a 35 U.S.C. § 111 (a) continuation of, PCT international application number PCT/US2022/045236 filed on Sep. 29, 2022, incorporated herein by reference in its entirety, which claims priority to, and the benefit of, U.S. provisional patent application Ser. No. 63/251,346 filed on Oct. 1, 2021, incorporated herein by reference in its entirety. Priority is claimed to each of the foregoing applications.

The above-referenced PCT international application was published as PCT International Publication No. WO 2023/055938 A2 on Apr. 6, 2023, which publication is incorporated herein by reference in its entirety.

### STATEMENT REGARDING FEDERALLY SPONSORED RESEARCH OR DEVELOPMENT

This invention was made with government support under Contract No. DE-AC02-05CH11231 awarded by the U.S. Department of Energy. The government has certain rights in the invention.

### BACKGROUND

### 1. Technical Field

The technology of this disclosure pertains generally to coherent beam combining, and more particularly to implementing machine learning for coherent beam combining in an unstable system.

### 2. Background Discussion

In complex systems, such as lasers and accelerators, it is important for systems to be maintained against environmental perturbations using an active stabilization controller. Often, there are challenges to identify errors and build a deterministic error detector, due to the large number of degrees of freedom, incomplete diagnostic information and non-linearity.

Machine Learning (ML) is a powerful tool, with neural networks that can map the complex/non-linearity function from measurement to a system error array, and then use feedback to quickly correct the system input.

Training a machine learning model requires a dataset consisting of the measured observation data and the corresponding sets of controller actions that have an influence on the system. The accuracy of the training dataset is critical for the precision of the ML model. To obtain accurate training samples, it requires the system to be at stable and reproducible states during training, which is impractical in real experiments due to system drift.

In a conventional, model-based, many-in-many-out control system design, it is critical to have the mathematical representation of the system transfer function, known as the system identification process, in order to optimize the controller design in stability and accuracy aspects. However, in many applications, this is difficult to do, and becomes a complex problem if the system is non-linear, time variant, or non-observable.

On the contrary, model-free controllers require a random dithering and searching process to map the multi-dimensional parameter space of the system under control, such as using stochastic parallel gradient descent (SPGD), which randomly dithers all the inputs and searches for an optimum set of values. Since the controller doesn't remember its experiences, the dithering process has to be continuous, causing additional perturbations to the system, and is very inefficient, and difficult to scale.

Machine learning also treats the system as a black box, it learns to map the function from observation to action in a deterministic way. Thus, it is able to provide rapid feedback and better performance in regard to stability. The previous ML method, trained with absolute values of input and output, requires training on a stable system, which is impractical in real experiments due to system drift; while it also requires periodic re-training.

Accordingly, the present disclosure overcomes these previous shortcomings and provides additional benefits.

### BRIEF SUMMARY

This disclosure describes a machine learning controller that can learn to stabilize systems based on measurements in an unstable system. This allows for training on a system not yet controlled and for continuous learning as the stabilizer operates.

The disclosed approach is based on obtaining two measurements close together in time, separated by a known differential interval at the input. The controller has improved performance on unstable systems compared to similar technologies, especially complex ones with many inputs and outputs. Furthermore, there is no need for modelling the physics, and the controller can adapt to un-analyzed or partially analyzed systems.

Instead of learning the absolute value of observation and action, in the present disclosure the machine learning (ML) controller learns differentially. For example, a known action is input, and the result are seen before and after (which is a multi-state in observation space), and this is performed quickly compared with parameter drifts. All of the information is present. The trained ML model is capable of building a map between the differential observation space and the controller action space.

During feedback, the system of the present disclosure feeds the trained neural network a current measurement (possibly unseen in the training dataset), together with a desired pattern in the observation space, and the neural network predicts the action needed to move the system between the two states in a deterministic way.

The system has numerous benefits and characteristics, briefly summarized below. The system is robust against drift during training. The system is capable of continuous learning while operating. The system automatically updates as the system changes so that there is no need to retrain. There is no need to otherwise stabilize the system while training.

Additionally, differential states training enables system identification on a free-drifting many-in-many-out system, without a knowledge of a mathematical model.

In applications where there is periodical non-uniqueness mapping, such as interferometric control on coherent beam combining, only a small fraction of the training dataset near the operating point is required, instead of mapping the entire parameter space. This is advantageous for obtaining rapid training speed on large scale systems.

Additionally, the neural network can be continuously retrained using the locking data, to capture slow transfer function change of the system, without introducing additional exploration actions or dithering.

Furthermore, the neural network prediction is deterministic and fast. Inference speed of tens of nanoseconds can be achieved on an FPGA device for coherent beam combining.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is a system flow diagram of an embodiment of an NN-based interference pattern recognition algorithm, trained with multi-state dither, in a stabilized control loop robust against phase drift, according to at least one embodiment of the present disclosure.

FIG. 2A is a plot of RMS error during training of the NN, according to testing of at least one embodiment of the present disclosure.

FIG. 2B is a plot of feedback for 50 cases using random sampling, with a drift rate of 6 degrees, according to testing of at least one embodiment of the present disclosure.

FIG. 2C is a plot of feedback for 50 cases using random sampling, with a drift rate of 8 degrees, according to testing of at least one embodiment of the present disclosure.

FIG. 2D is a plot of feedback for 50 cases using random sampling, with a drift rate of 14 degrees, according to testing of at least one embodiment of the present disclosure.

FIG. 3 is a block diagram showing an experimental optical setup for stabilized beam combination, according to at least one testing embodiment of the present disclosure.

FIG. 4A are plots of time history of output beam powers and DAC outputs before and after activating CALIPR, according to testing of at least one embodiment of the present disclosure.

FIG. 4B are output diffraction patterns, according to testing of at least one embodiment of the present disclosure.

FIG. 4C are plots of out-of-loop measurements of combined and side beam power, according to testing of at least one embodiment of the present disclosure.

FIG. 5A is a training diagram for a neural network that stabilizes drift in a beam combiner, according to at least one embodiment of the present disclosure.

FIG. 5B is an feedback operation diagram for drift stabilization using the neural network trained according to FIG. 5A.

FIG. 6A is a flow diagram showing a neural network being trained with two patterns and a fast phase dither in a coherent beam combiner according to an embodiment of the presented technology.

FIG. 6B is a flow diagram showing feedback by correcting a predicted phase error using the neural network trained according to FIG. 6A.

FIG. 7 is a flow diagram showing am embodiment of a generalized neural network feedback loop for stabilizing drift in a controlled system according to the presented technology.

### DETAILED DESCRIPTION

### 1. Introduction to CALIPR

Coherent beam combining is a promising technique for laser power scaling, and is key to a broad range of applications. Laser energy can be combined in different ways, including temporal pulse stacking and spatial beam addition using schemes such as binary tree, tiled aperture and filled aperture diffractive combining. In all cases, it is imperative that the coherence of the whole beam array be maintained against environmental perturbations using an active stabilization controller. Often, there are challenges to identify errors and build a deterministic error detector, due to the large number of degrees of freedom, incomplete diagnostic information, non-linearity, measurement noise, and most importantly, the spontaneous system phase state drift.

To address these challenges the present disclosure describes a technology that we refer to as “Coherent Addition using Learned Interference Pattern Recognition” or “CALIPR” for short. In one embodiment, CALIPR reads interference patterns at the combiner output, derives a phase error array, and feeds back to quickly correct the input beams or pulses. CALIPR also employs a unique multi-state training scheme to capture the system characteristic into a neural network, and to detect errors for correction from measured interference pattern recognition in a deterministic way.

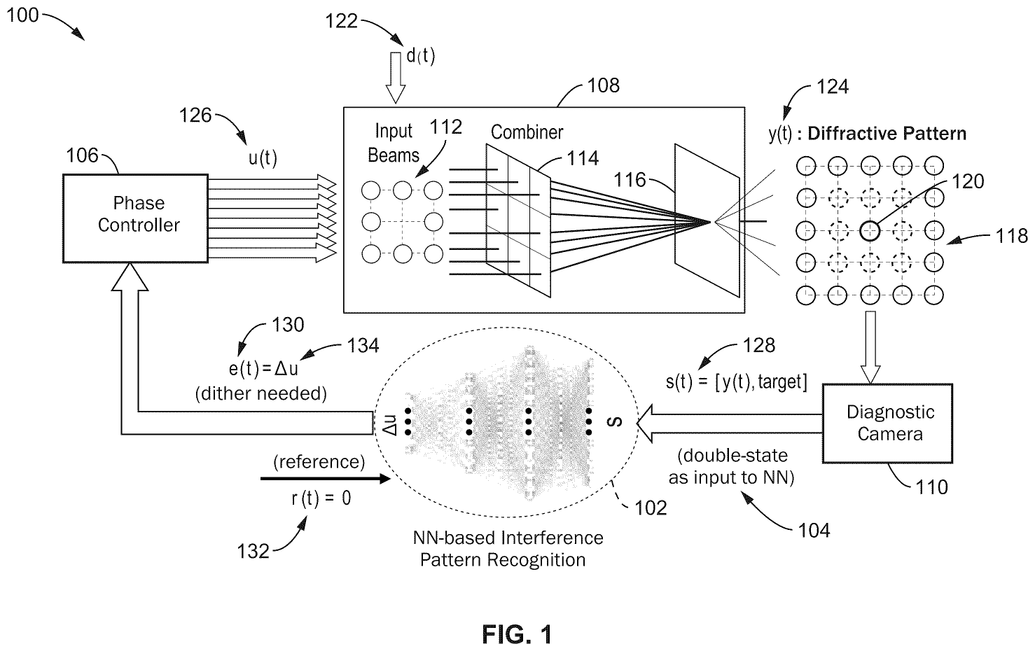

FIG. 1 is a schematic illustrating an embodiment 100 of a neural network (NN) based method of stabilizing a system against drift shown in the context of a diffractive laser combining system.

In the embodiment shown in FIG. 1, the NN 102 comprises an interference pattern recognition algorithm that is trained with multi-state dither 104 (e.g., at least a double-state pair), and positioned in a stabilized control loop robust against phase drift. Using control variables based on error recognition algorithms (mapping function between measurement and system errors), a controller 106 corrects system errors in order to stabilize the output of a plant/system 108. The system output is measured using a diagnostic sensor (e.g., camera) 110 to provide an input stream to the NN.

In the plant/system 108, by way of example and not limitation, an 8-beam individual input laser beams (in a 3×3 array) 112 are combined by a diffractive optics element (combiner 114, 116), into 5×5 (25-beam) interference diffractive patterns 118. The optimal pattern has a very bright power 120 in the center that combines most of the power from all the individual input beams. At the designed work condition (target pattern), the center beam 120 in the diffractive pattern is the brightest, with maximum power and maximum combining efficiency. Otherwise, if the input (before the combiner) is changed, the diffractive pattern is off optimal (not optimal), with lower center beam power and extra power loss into the side beams.

The notation d(t) 122 indicates different drift/noise/perturbation from the environment that can change the diffractive pattern. It should be noted that d(t) is unknown and uncontrollable.

The diagnostic sensor 110 measures the real-time diffractive pattern y(t) 124, which contains the information of system error, but it is incomplete and non-unique due to the loss of phase information.

The phase controller 106 corrects the input laser beam phase with control signal(s) u(t) 126, to compensate for the system errors based on the measured intensity pattern y(t) from the diagnostic sensor. In one embodiment, the controller is implemented with a NN-based interference pattern recognition algorithm 102 that is trained with a multi-state dither scheme 104 such as a double-state pair. The input to the NN, s(t) 128 where s(t)=[y(t), target], is the current diffractive pattern together with the target pattern. The NN algorithm works as a mapping function from s(t) 128 to system error e(t) 130, comparing e(t) to the reference 132 (r(t)=0). Then, the NN algorithm recognizes the control variables Δu 134 for the controller, i.e., the needed dither to bring the system output back to the target. As the feedback loop is on, the controller can always stabilize the system near target against environment drift.

Notably, CALIPR is model-free, calibration-free, and can be implemented on various types of processors and process-controlled devices, including a standard computer, or can be implemented on a GPU/FPGA platform for fast real time performance. Notably the technology provides a method that enables a simple neural network that can be ported to a FPGA device for real time performance.

In the following discussion, we focus on design, optimization and numerical simulations, based on our previous work with a 3×3 combiner and a 9×9 combiner. See, for example:
1. Wang, Dan et al., “Stabilization of 81 channel coherent beam combination using machine learning”, Optics Express, Vol. 29, No. 4 (2021), pp. 5694-5709, published Feb. 8, 2021.
2. Du, Qiang et al., “81-Beam Coherent Combination Using a Programmable Array Generator”, Optics Express, Vol. 29, No. 4 (2021), pp. 5407-5418, published Feb. 4, 2021.
3. Du, Qiang et al., “Deterministic stabilization of eight-way 2D diffractive beam combining using pattern recognition”, Optics Letters, Vol. 44, No. 18 (2019), pp. 4554-4557, published Sep. 11, 2019.

### 2. Interference Pattern Recognition

### 2.1 Neural Network (NN) Based Pattern Recognition

In a diffractive combiner, a neural network can be trained to recognize diffraction intensity patterns and translate them into an absolute beam phase error array, despite non-unique interference patterns in 2π phase, nonlinearity and noisy measurements. The training range only needs to be a small fraction of the full multidimensional phase space. However, such absolute phase recognition requires the combiner to be stable and have reproducible phase states during training, which is impractical in real experiments due to phase drift.

### 2.2 Phase Drift

For simulation purposes, in these tests we added phase drift as Brownian Motion, which is random and can have large values that accumulate with time. We set the RMS value of drift rate σ_{Δd}, i.e., the phase drift within one measurement, to evaluate the drift rate. In the experimental results described below, the RMS drift rate is about 3.5 degrees. In the simulation, we have drift rate as a scanned parameter to study the limit of CALIPR against drift, which can go as fast as 14 degrees RMS.

### 2.3 Multi-State Dither

The problem of deceptive absolute phase recognition due to phase drift can be solved by CALIPR using a multi-state training scheme. The multi-state training can be a double-state, or more states, used for training. The neural network is trained using a large number of samples, each comprising a set of two or more interference patterns and a random phase dither. If the random dither is faster than phase drift, the trained neural network is capable of building a map between the differential phase space and a double-frame diffraction pattern space. In feedback, if we input the measured pattern and the target diffraction pattern with the highest combining efficiency, the neural network can predict the phase error in between, within an accuracy depending on the training parameters.

### 2.4 Sampling Method

Samples used to train the NN are required to be within a limited phase range ([−π/2, π/2]) around the optimal state, to avoid the ambiguity of pattern recognition in the full 2π range. Randomly chosen samples can be used when drift is slow (drift rate σ_{Δd}<6 degrees) as we start from the optimal state. It fails for fast drift rates (σ_{Δd}≥8 degrees), as even for a small number of samples the system drift would bring phase over the TT range. Thus, the present disclosure uses the selected sampling method which only uses the patterns near optimal as samples to train the NN and get rid of patterns with low combining efficiency to avoid ambiguity.

### 3. Performance

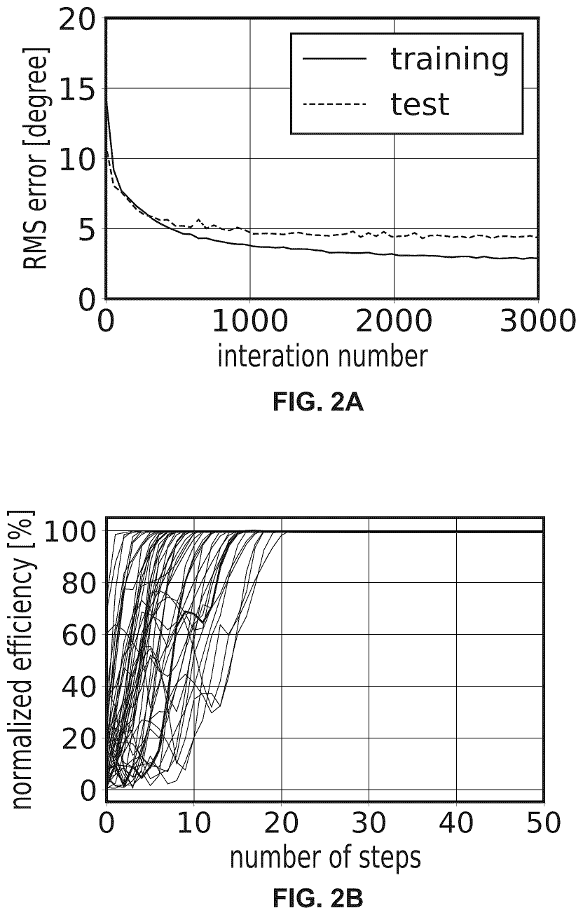

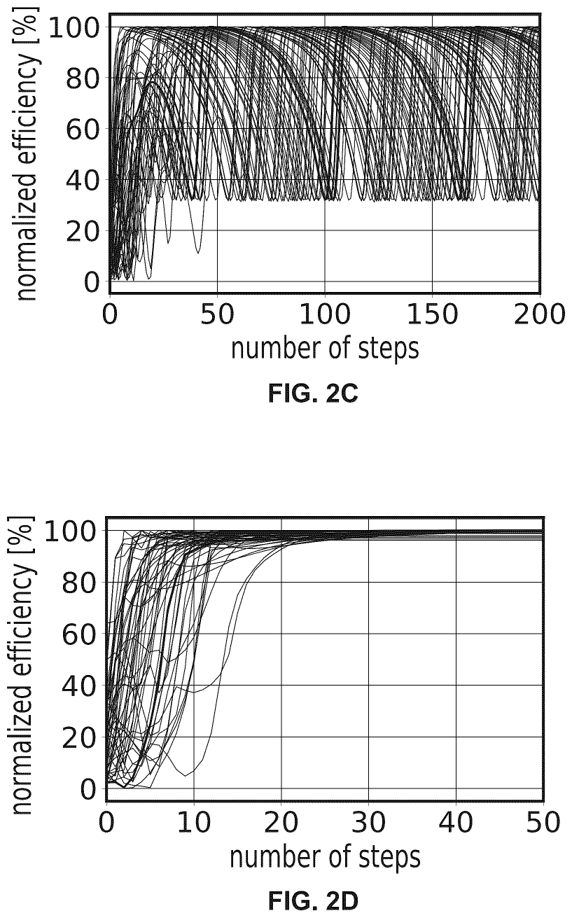

FIG. 2A and FIG. 2B show training of the NN and CALIPR performance on feedback at different drift rates with random sampling or selected sampling methods. in FIG. 2A the RMS error between the predicted phase and the known phase drops as the NN is trained. It is expected to be large as shown in FIG. 2A, because our known phase neglects system drift, while the measurement includes system drift.

The NN was trained with 1k known interference patterns, randomly selected at first, which can feedback within an average of less than 10 steps for drift rate σ_{Δd}=6 degrees (as seen in FIG. 2B). This approach fails for drift of σ_{Δd}=8 degrees during training, as shown in FIG. 2C. To allow for faster drift, we selected 1k samples near the optimal point, and successfully tested the stabilizer on drift of σ_{Δd}=14 degree as shown in FIG. 2D. Results indicate the strength of CALIPR against fast drift.

### 4. Experimental

Large numbers of beams can be combined with high efficiency using diffractive optics, increasing the power of otherwise limited lasers, particularly fiber lasers. The output of a diffractive beam combiner includes side beams (interference patterns) which contain information giving the phase of the input beams, and these can be analyzed to yield phase error correction signals. Otherwise, these interference patterns can be “learned” by a machine without actual analysis, which is useful when the patterns are complex.

In this example, a CALIPR implemented machine is illustrated with many examples of mistuned beams and the consequent efficiency loss. The machine learns to recognize phase errors from their side beam signature, providing for single-step correction.

Training the machine to recognize patterns and corresponding input phase states implies the patterns are stable enough to be measured and correlated with controlled phases. This may not be the case in a realistic fiber laser system where thermal drifts are causing phase to continuously vary. It is possible to stabilize the phases using a noisier, less robust algorithm, such as Stochastic Parallel Gradient Descent (SPGD), while the machine learns. Alternatively, one can make the training process robust against drift. This can be done, for example, by training using the difference between two observations as the input phases are changed in a controlled way, basically finding a difference rather than an absolute value. This two-state dither scheme allows the phases to drift during training, because the two measurements are acquired in a short time interval compared with the drift rate. In our experiment, using a dither interval of 30 degrees RMS applied over 25 ms, there can be random drift of less than 3:5 degrees. To minimize the number of required training steps and increase prediction accuracy, the dither intervals are randomly chosen from a set of orthogonal vectors in 8-dimensional space.

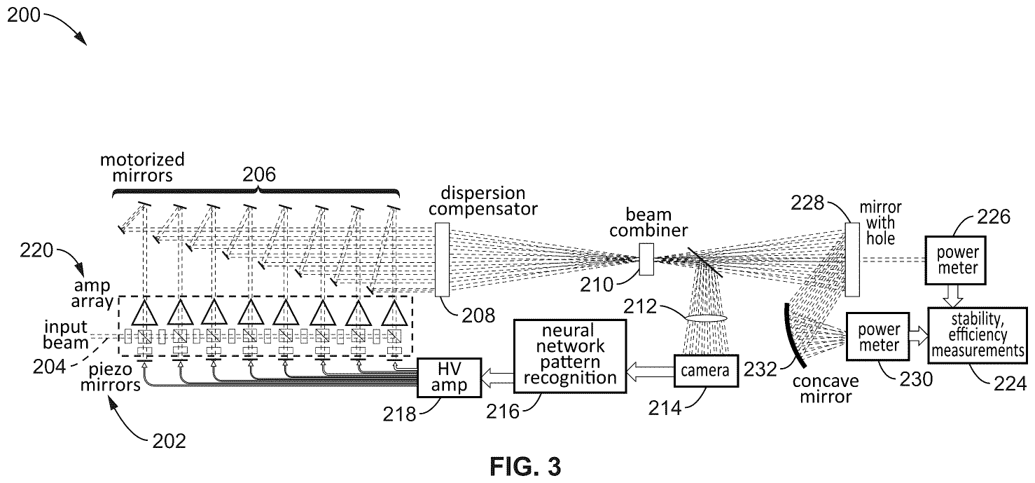

FIG. 3 illustrates an example optical setup 200 using the stabilized beam combination. We demonstrated CALIPR-based stabilization control in an experiment on an 8-beam (3×3 array) filled aperture diffractive combiner system, showing <0:4% RMS combined beam stability at optimal efficiency.

The configuration shown in FIG. 3 is designed to equalize delays and combine an array of high-energy fiber amplifiers seeded by signals successively picked off from a central beam. For the tests, a plurality of piezo-actuated mirrors (piezo mirror) 202 were used for phase control, using a single-frequency CW laser as a source (input beam 204), split eight ways using a separate diffractive optic. An array of mirrors (motorized mirrors 206) forms the eight beams into a 3×3 matrix with no center beam, which is then incident on the dispersion compensating diffractive optic (dispersion compensator 208). After passing through the diffractive combining optic (beam combiner 210), a fraction of the output power is passed through a lens 212 to a camera 214 that images the far-field spots, showing interference patterns associated with the input beam array phase state. This information is processed by the neural network 216 to yield error signals applied to the high voltage amplifiers (HV amplifiers 218), which then drive the piezo mirrors 202 to shift optical phases and stabilize the system against variable perturbations. Optical signals from the piezo mirrors can be amplified if needed using an amplifier array 220.

Meanwhile, the test measured stability and combining efficiency 224 when the control loop is closed. Here, the test measures the intensity of central combined beam power with a power meter 226 after a mirror with a hole 228, which is independent of the control loop. The combining efficiency, defined as the ratio of the central combined beam power to the total power from all twenty-five diffracted beams, is measured with another power meter 230 after the concave mirror 232 and mirror with hole 228 (output through the hole directed to power meter 226 coupled to 224).

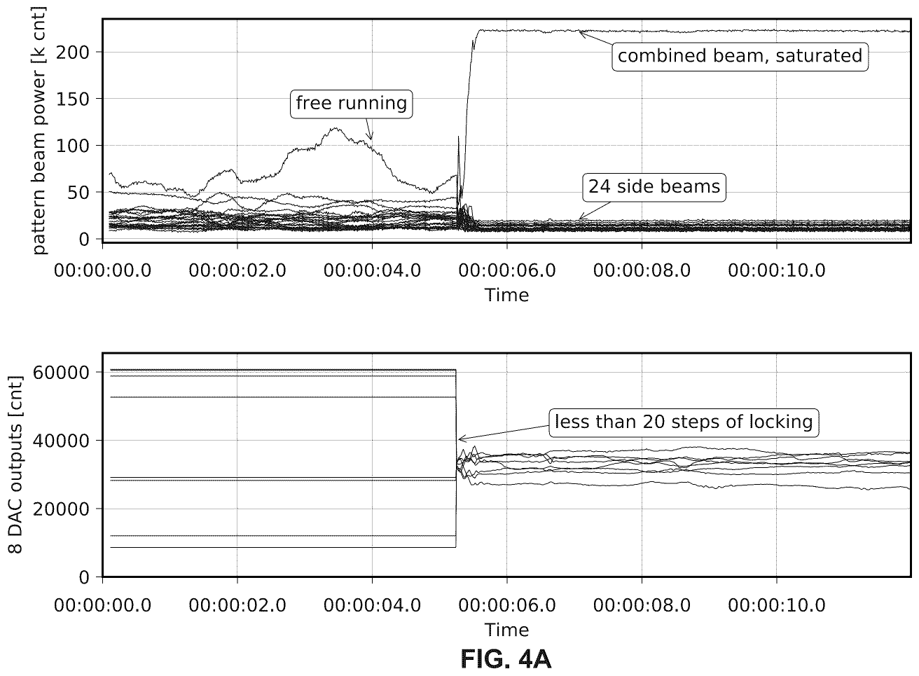

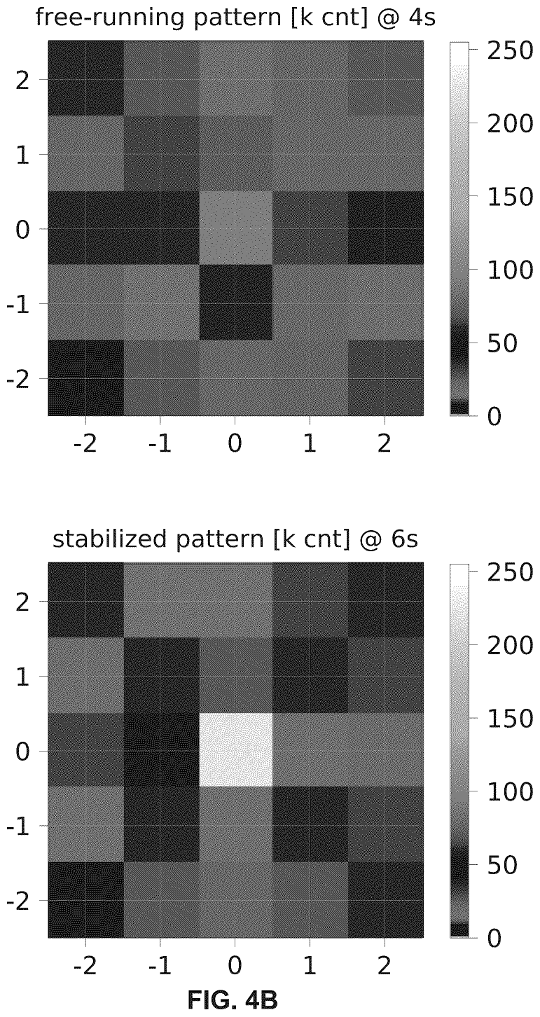

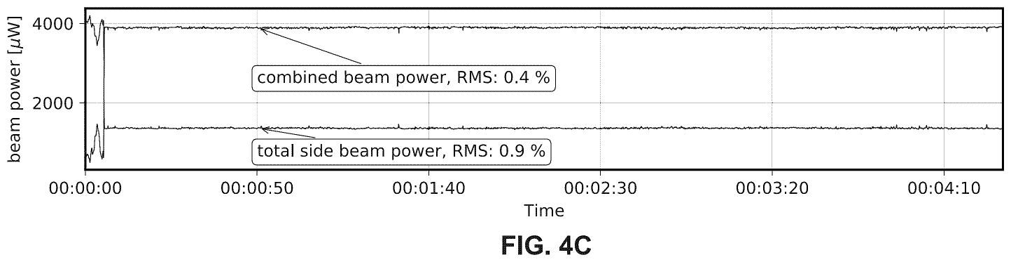

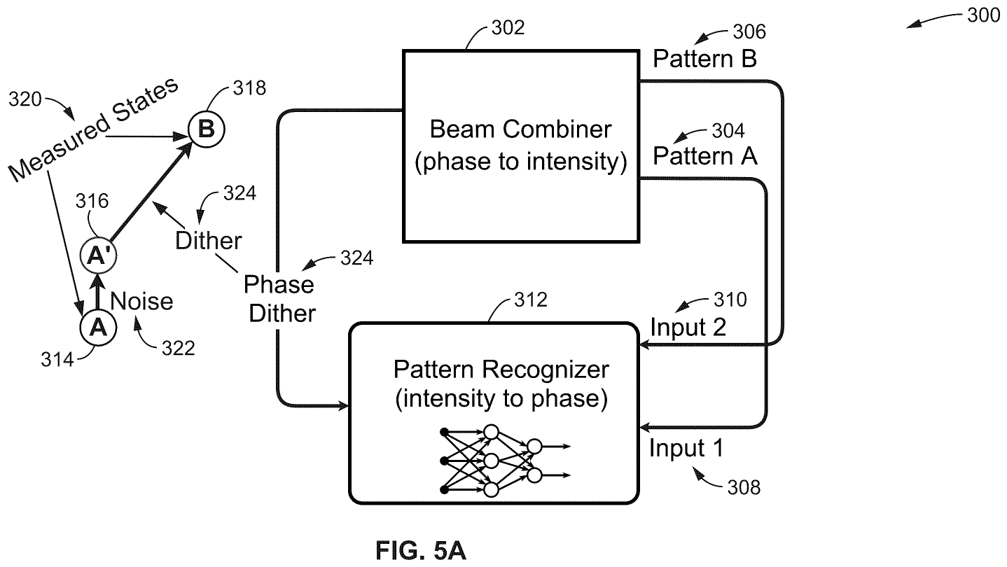

FIG. 4A through FIG. 4C illustrate different measurements taken in the example system of FIG. 3.

Training takes approximately 8,000 measurements over a period of 3.3 minutes, resulting in an RMS prediction error of about 11 degrees. Once this process is complete, the trained neural network is presented with a measured diffraction pattern and the best pattern it has seen in the training dataset (the target), so that the predicted phase error array can be used for feedback and maintain the system phase state against perturbations, as shown in FIG. 4A. In the upper plot of FIG. 4A is seen a plot of pattern beam power with respect to time. Before locking occurs, the free running beams are seen, then after locking a saturated combined beam is shown with 24 side beams at the bottom of this plot. The lower plot of FIG. 4A depicts the 8 DAC outputs with respect to time, and showing the locking takes place in less than 20 steps.

In FIG. 4B is shown interference patterns before (free-running) and after (stabilized pattern) the beams are combined.

In FIG. 4C is seen out-of-loop power meter measurements (in microwatts) of the combined and total side beam powers, where stability of the combined beam is RMS 0.4% after locking. For comparison, when implementing an SPGD algorithm the stability was observed to be 8.8% RMS. In addition to adding noise from random dither, the SPGD recovers slowly from perturbations. The pattern recognition scheme of the present disclosure recovers in one cycle, and this is true for any number of beams, whereas the latency of SPGD scales with the number of beams. The measured combining efficiency (center beam power divided by side beams power) is 74%. This is lower than our previous result of 86%, possibly due to a bad beam. In the testing we purposely blocked one beam, and the retrained NN is still capable of locking seven beams with similar performance. Additionally, in testing the present disclosure we quantized the NN and implemented it on an FPGA which has a direct camera interface, and demonstrated a frame rate of 800 frames per second.

### 5. Deep Learning Based Control; Simulation, Training and NN Feedback

Deterministic stabilization in a beam combiner can be achieved by pattern recognition, after characterizing the transmission function of the combiner optic, where the pattern recognition process used for system control recognizes the control variables of input beam phases based on the measured intensity patterns. A machine learning controller is an effective solution and mapping information can be learned from experimental data.

Since drift/disturbances exist in most systems, the NN needs to be trained on a drifting system in order to be effective. If the system could be completely trained before any significant drift, that would work, but with the current sample rates, this is not possible. Several thousand samples are required and, with a sample time of 1 kHz for example, this would require several seconds during which time the drift will be unacceptable. Furthermore, parameters that are not controlled by the phase actuator (such as relative beam power) change during long-term operation and cause the phase/pattern correlations to change.

Accordingly, the present disclosure presents a solution which we refer to in this disclosure as the “Deterministic Differential Remapping Method” or “DDRM” for short. In at least one embodiment, this solution trains the NN to correlate pattern differences with phase differences so that the NN can be trained on a drifting system, and then retrain the NN during operation in order to track changes. The NN becomes a device that learns which differences in interference patterns are correlated with which vectors in phase space, so that given an ideal pattern, it can find the error vector for feedback.

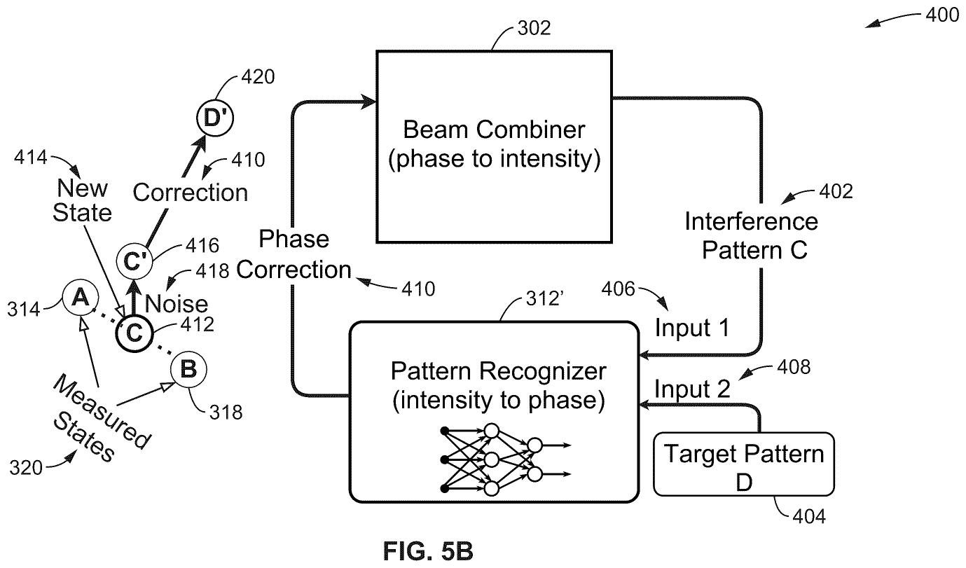

FIG. 5A and FIG. 5B illustrate an embodiment of DDRM applied to a coherent laser combining system. FIG. 5A shows training 300 and FIG. 5B shows feedback 400. DDRM captures the system characteristic into a neural network, and detects errors for correction from measured interference pattern recognition in a deterministic way. DDRM maps between a multi-state diffraction pattern space and the corresponding differential phase space. By training the NN to correlate pattern differences with phase differences, training can be performed on a drifting system and then retrained during operation in order to track changes. The NN becomes a device that learns which differences in interference patterns are correlated with which vectors in phase space, so that given an ideal pattern, it can find the error vector for feedback.

In FIG. 5A, the neural network is trained with two patterns and corresponding phase dither therebetween. While two patterns and dither are shown as an example (e.g., double-state dither), the approach is not limited to two states and should be considered a multi-state approach. In this embodiment, the beam combiner 302 serves as a mapping function from laser phase to intensity pattern. Intensity pattern A (304) and intensity pattern B (306) can be measured with a sensor such as a camera and the measurements serve as input 1 (308) and input 2 (310) to the neural network (NN) pattern recognizer 312.

The neural network pattern recognizer 312 used for control is the reverse of a combiner, and performs a mapping function from intensity patterns to the phase space. The measured intensity patterns 304, 306 (pattern A and pattern B, respectively) on the right side of FIG. 5A are associated with the phase states A (314), A′ (316) and B (318) shown in circles on the left side of FIG. 5A. Phase states 314 and 318 are measured states 320, and phase state 316 is phase state 314 plus noise 322. It should be noted that the absolute beam phase state is unknown due to drift and noise. The only known quantity in the phase space is the active phase dither 324 that is injected between pattern A and pattern B. Accordingly, differential space is used rather than absolute values.

More particularly, a known phase dither 324 is injected and intensity patterns are measured before and after injection (pattern A and pattern B). Then correlated data samples of [pattern A, phase dither, pattern B] are used to train the NN pattern recognizer 312. The trained NN pattern recognizer then becomes a device that learns which differences in interference patterns are correlated with which vectors in phase space, so that given an ideal pattern, it can find the error vector for feedback.

FIG. 5B illustrates feedback 400 for correcting a predicted phase error between a current (measured) pattern and a target pattern. After the training process in FIG. 5A, the trained NN becomes a device 312′ that learns which differences in interference patterns are correlated with which vectors exist in phase space. For example, with a given measured interference pattern C (402), together with a target pattern D (404) as input 1 (406) and input 2 (408), respectively, the NN pattern recognizer 312 can find the error vector, i.e., phase correction 410, for feedback correction.

The phase state diagram on the left side of FIG. 5B shows the phase states A (314) and B (318) as the measured states 320, Pattern C (412) is a new state 414 for the pattern recognizer 312′, which is typically unseen in the training dataset. Pattern C′ (416) is pattern C (412) plus noise 418. The neural network acts like a multidimensional interpolation to predict the distance vector (correction 410) from pattern C′ (416) to the near target state D′ (420) from its experience of 314, 318.

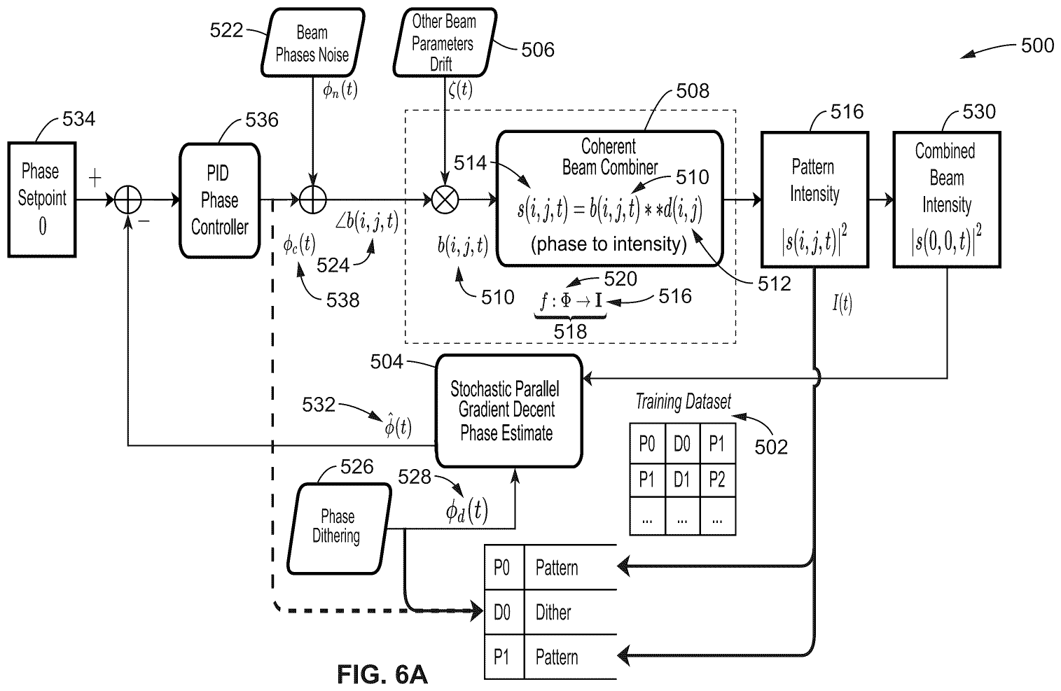

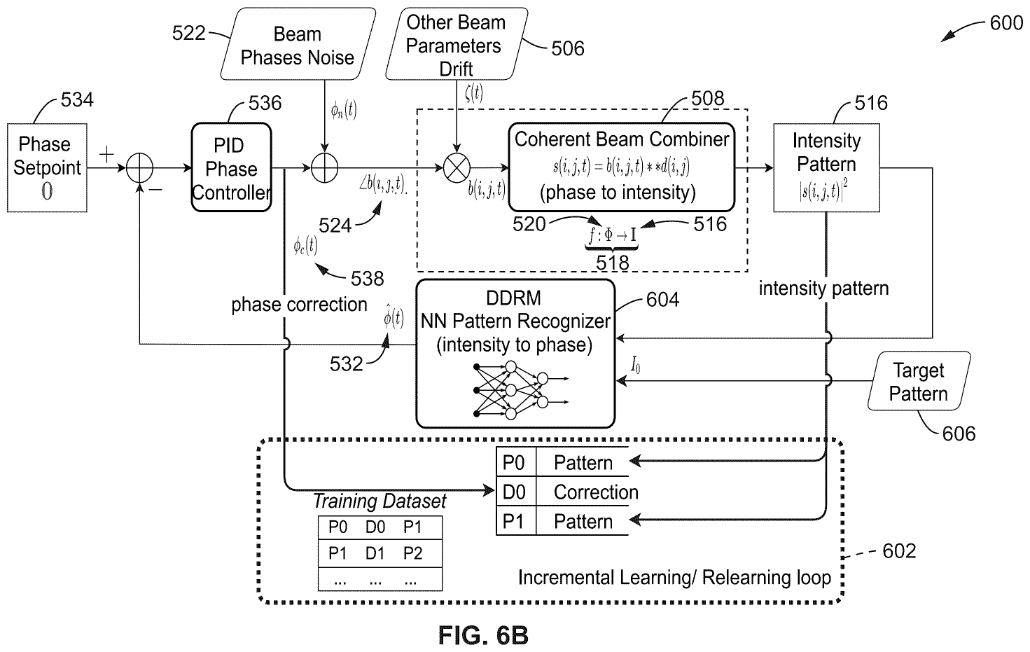

FIG. 6A is a flow diagram for an embodiment 500 of a process for obtaining a training dataset 502 with conventional Stochastic parallel gradient descent (SPGD) algorithms 504 for a phase estimation/error recognition in the feedback loop for stabilizing against drift 506 in a coherent beam combiner 508. This flow diagram can serve as the basis for creating code for executable instructions for processor-based implementations.

The physics process of diffractive combining can be represented as a discrete 2D convolution:

$$s ( i , j , t ) = b ( i , j , t ) ** d ( i , j ) \qquad ( 1 )$$

where b(i, j, t) 510 is the time-varying input beam function, d(i, j) 512 is the intrinsic DOE transmittance function, and s(i, j, t) 514 is the corresponding complex far-field of the diffracted beam and the pattern intensity I=|s(i, j, t)|² 516. I(t) in FIG. 6A is the time varying pattern intensity 516 at a point in time (t).

Here, (i, j) is the horizontal and vertical coordinate of both the input beam array (i, j=[−2, −1, . . . 0, . . . 1, 2]), and the far-field diffracted beam array from the incident direction, with the zero-order beam located at (0,0). In general, as 2D convolution suggests, for N×N inputs and N×N shaped d(i, j), there will be (2N−1)×(2N−1) outputs. For the 3×3 input beams, the output pattern is a 5×5 array.

The diffractive combining system serves as a mapping function ƒ 518, from phase space ϕ 520 to the intensity pattern space (I=|s(i, j, t)|²) 516. Each time the input beam b(i, j, t) 510 is changed/updated, either by the beam phase noise (ϕₙ(t)) 522, or other beam parameter drift (ξ(t)) 506, or the feedback control signal to correct the laser beam phase ∠b(i, j, t) 524 (here “∠” stands for the angle or phase), then Eq. 1 is utilized to update the intensity patterns in the code.

The SPGD algorithm optimizes and stabilizes the system by dithering and searching. In each iteration, a phase dithering routine 526 generates a random dither ϕ_{d} (t)=[D0, D1, D2 . . . in time series] 528, a gradient is calculated based on the intensity of the center combined beam in the pattern (|s(0,0, t)|²) 530 after dithers, \hat{ϕ}(t) 532 is calculated as the error signal, and the error signal is compared with the phase setpoint 0 (534) and sent to the controller 536. In this example, we are using a simple proportional-integral-derivative (PID) controller to send the control signal (ϕ_{c}(t)) 538 to correct the laser beam phase ∠b(i, j, t) 524.

The SPGD loop stabilizes the phase state near-optimal. Intensity pattern pairs [P0, P1] that are recorded before (e.g., P0) and after (e.g., P1) the active phase dither D0, form the labeled training set 502 for the NN as [P0,D0, P1], [P1, D1, P2], and so forth. Either the SPGD phase dithering action ϕ_{d}(t) and pattern pairs, or the controller correction action ϕ_{c}(t) and pattern pairs, can be used.

For DDRM, the training samples can be from the recorded observation and action pair of any existing controller that can roughly maintain the optimal combining state. Here we have shown that such a controller can be the popular SPGD process. The controller can also be a neural network-based controller itself, which in turn becomes a continuous relearning process that can capture and track the system variants.

FIG. 6B is a flow diagram showing an embodiment 600 of a process for stabilizing the system against drift using the trained NN pattern recognizer in a feedback loop with an incremental learning/relearning loop 602. As with FIG. 6A, this flow diagram can serve as the basis for creating code for executable instructions for processor-based implementations. A number of the same elements from FIG. 6A are shown in this figure.

Once trained, the NN pattern recognizer 604 becomes a mapping function (ƒ⁻¹), which is opposite to the combining system (ƒ) 518. The NN pattern recognizer 604 maps from the intensity space (ƒ) 516 to the control variable/phase space (ϕ). Accordingly, the NN pattern recognizer 604 becomes a device that learns which differences in interference patterns are correlated with which vectors in phase space (control variable space), so that given a measured diffractive interference pattern |s(i, j, t)|² 516, together with a target pattern Iₒ 606, the NN pattern recognizer 604 can find the error vector, i.e., phase corrections (\hat{ϕ}(t)) 532, for feedback corrections to update the input beam phase ∠b(i, j, t) 524. With an updated input beam, 2D convolution (Eq. 1) can be utilized to get the updated pattern in the code and check the feedback performance, such as feedback efficiency and stability of the NN pattern recognizer in simulations.

It should be noted that in the simulation, we always have random noise (ϕₙ(t)) 522 and parameter drift ξ(t)) 506 in each step, and our approach turns out to be robust against fast drift.

### 6. Generalized Neural Network Feedback for Drift Stabilization

Based on the foregoing description, it will be appreciated that the technology described herein can be used in a feedback loop for stabilizing any system that experiences drift and is not limited to stabilizing drift in a beam combining system.

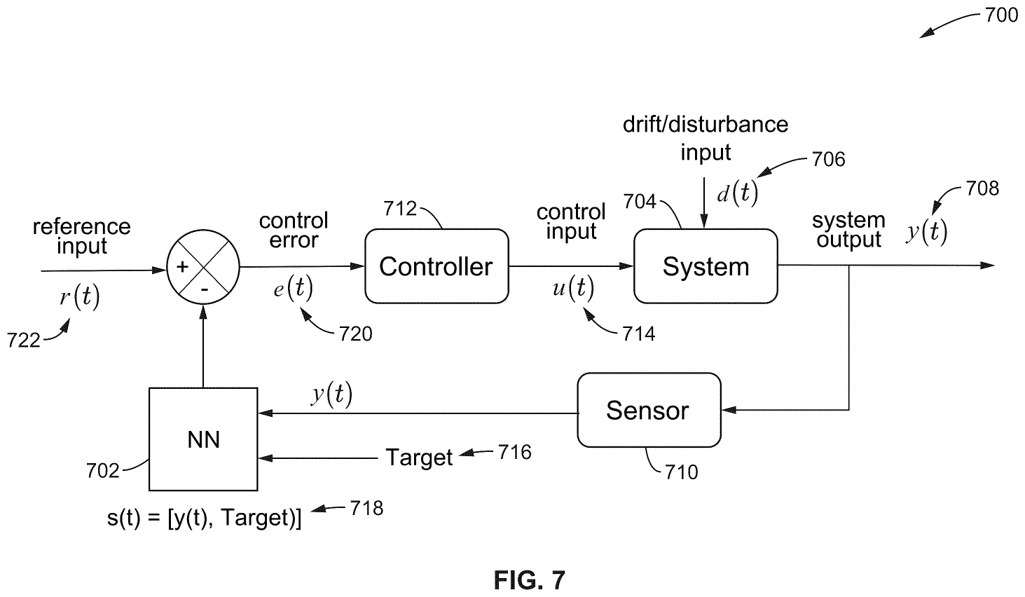

FIG. 7 schematically illustrates a generalized embodiment 700 of a neural network (NN) 702 trained and configured for stabilizing drift in a system 704. The notation d(t) 706 indicates drift/noise/perturbation in the system that can affect the system output y(t) 708.

The NN is trained with multiple samples of system output y(t) and other information if desired. In one embodiment the sample that is closest to the desired output is selected as a target 716.

After the NN 702 is trained, the sensor 710 measures the real-time system output y(t) 708 and the controller 712 corrects the system for drift with control signals u(t) 714. The NN 702 generates control variables for the controller 712 which in turn generates the control signals u(t) 714.

In operation, a target 716, along with values of y(t) 708 measured from the sensor 710, are input to the NN 702 as s(t) 718 where s(t)=[y(t), target]. The NN 720 maps s(t) 718 to system error. The control error e(t) 720 is generated, by comparing the reference 722 (r(t)=0) and the control variables generated by the NN, for the controller 712 to in turn generate control signals Δu 714. For example, the dither/correction needed to bring the system output back to the target. While the feedback loop is operational, the controller can stabilize the system near target against environment drift.

It will further be appreciated that the apparatus can be embodied in other equivalent ways. For example, the NN 702 and sensor 710 could be implemented as a single device, such as a smart sensor, where the NN serves as an algorithm to detect distance vectors to the target in the control variables' space, based on, for example, a conventional sensor output (e.g., camera images).

### 7. General Scope of Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A machine-learning based stabilized beam combining apparatus, comprising: an optical phase controller; an optical beam combining system; a neural network configured to be trained with multi-state dither information from the optical beam combining system; wherein the neural network is configured to, after being trained with labelled data as said multi-state dither, to map (i) a target and (ii) interference diffractive patterns measured from the optical beam combining system, to error in the interference diffractive patterns measured from the optical beam combining system, and compare the error to a reference; wherein, based on said comparison, the neural network is configured to generate phase control variables as feedback on error correction for the optical phase controller to compensate for drift and noise in the optical beam combining system and adjust system output to near target; and wherein the neural network is configured to send the generated phase control variables to the optical phase controller, whereby the optical phase controller can use the generated phase control variables to stabilize the optical beam combining system against drift and noise.

The apparatus of any preceding or following implementation, wherein said apparatus allows training on a system not yet controlled and for continuous learning as the stabilizer operates.

The apparatus of any preceding or following implementation, wherein said multi-state dither information is obtained differentially with a known action being input, the results of which are registered before and after, thus providing a multi-state in observation space, from which a trained neural network is capable of building the map between the differential observation space and the controller action space, as opposed to conventional learning requiring observation of absolute value and action.

The apparatus of any preceding or following implementation, wherein training with said multi-state dither information enables identification on a free-drifting many-in-many-out system, without a knowledge of a mathematical model.

The apparatus of any preceding or following implementation, wherein the feedback is configured to feed the neural network, after training, a current measurement, which need not be contained in a training dataset, together with a desired pattern in the observation space, from which the neural network predicts the action needed to move apparatus output between these two states in a deterministic way.

The apparatus of any preceding or following implementation, wherein said apparatus is capable of continuous learning while operating.

The apparatus of any preceding or following implementation, wherein said apparatus automatically updates its training as conditions change whereby there is no need to retrain.

The apparatus of any preceding or following implementation, wherein said apparatus does not require being stabilized during the multi-state dither information training process.

The apparatus of any preceding or following implementation, wherein said apparatus, operating in an application subject to periodical non-uniqueness mapping, requires only a fraction of the training dataset near the operating point, instead of mapping the entire parameter space, toward obtaining rapid training speed on large scale systems.

The apparatus of any preceding or following implementation, wherein said periodical non-uniqueness mapping comprises interferometric control on coherent beam combining.

Training a neural network for pattern recognition using multi-state dither information.

A neural network for pattern recognition that has been trained with multi-state dither information.

A neural network positioned in a feedback loop to stabilize drift in a system wherein the neural network has been trained with multi-state dither information and corrects system output error by mapping system output to a target.

An apparatus for stabilizing drift in a system, the apparatus comprising: a neural network that is trained with output signals from the system, wherein the trained neural network maps a target and output signals from the system to system error, compares the system error to a reference, and generates control variables for a controller coupled to the system to adjust system output to near target whereby the system is stabilized against drift.

A method for stabilizing drift in a system, comprising: training a neural network with output signals from the system, wherein the trained neural network maps a target and output signals from the system to system error, compares the system error to a reference, and generates control variables for a controller coupled to the system to adjust system output to near target whereby the system is stabilized against drift.

A machine-learning based apparatus for stabilizing drift in a system, the apparatus comprising: a neural network configured to be trained with measured output signals from the system, the measured output signals including system drift; wherein the neural network is configured to, after being trained, map the output signals and a target to system error and compare the system error to a reference; wherein, based on said comparison, the neural network is configured to generate control variables for a controller to compensate for the system drift and adjust output signals from the system to near target; and wherein the neural network is configured to send the generated control variables to the controller, whereby the controller can use the generated control variables to stabilize the system against drift.

In a system having a system input, a system output, a controller coupled to the system input, the controller having an input and an output, the improvement comprising: a neural network positioned in a feedback loop between the controller input and the system output; the neural network configured to be trained with measured output signals from the system, the measured output signals including system drift; wherein the neural network is configured to, after being trained, map the measured output signals and a target to system error and compare the system error to a reference; wherein, based on said comparison, the neural network is configured to generate control variables for the controller to compensate for the system drift and adjust the system output near target; and wherein the neural network is configured to send the generated control variables to the controller, whereby the controller can use the generated control variables to stabilize the system against drift.

A method for stabilizing a system against drift, the system having a system input, a system output, a controller coupled to the system input, a controller input, and a controller output, the method comprising: positioning a neural network in a feedback loop between the controller input and the system output; training the neural network with output signals from the system, the measured output signals including system drift; wherein after being trained the neural network maps the system output signals and a target to system error and compares the system error to a reference; wherein, based on said comparison, the neural network generates control variables for the controller to compensate for the system drift and adjust output signals from the system to near target; and sending the generated control variables to the controller input, whereby the controller can use the generated control variables to stabilize the system against drift.

A machine-learning based stabilized beam combining apparatus, comprising: an optical phase controller; an optical beam combining system; a neural network configured to be trained with multi-state dither information from the optical beam combining system; wherein the neural network is configured to, after being trained, map (i) a target and (ii) interference diffractive patterns measured from the optical beam combining system, to error in the interference diffractive patterns measured from the optical beam combining system, and compare the error to a reference; wherein, based on said comparison, the neural network is configured to generate phase control variables for the optical phase controller to compensate for drift in the optical beam combining system and adjust system output to near target; and wherein the neural network is configured to send the generated phase control variables to the optical phase controller, whereby the optical phase controller can use the generated phase control variables to stabilize the optical beam combining system against drift.

A machine-learning based apparatus for stabilizing an optical beam combining system against drift, the apparatus comprising: a neural network configured to be trained with multi-state dither information from an optical beam combining system; wherein the neural network is configured to, after being trained, map (i) a target and (ii) interference diffractive patterns measured from the optical beam combining system, to error in the measured interference diffractive, and compare the error to a reference; wherein, based on said comparison, the neural network is configured to determine phase control variables for the optical phase controller to compensate for drift in the optical beam combining system and adjust system output to near target; and wherein the neural network is configured to send the generated phase control variables to the optical phase controller, whereby the optical phase controller can use the generated phase control variables to stabilize the optical beam combining system against drift.

In an optical beam combining system having a system input, a system output, an optical phase controller coupled to the system input, the optical phase controller having an input and an output, the improvement comprising: a neural network positioned in a feedback loop between the controller input and the system output; the neural network configured to be trained with multi-state dither information from the optical beam combining system; wherein the neural network is configured to, after being trained, map (i) a target and (ii) interference diffractive patterns measured from the optical beam combining system, to error in the measured interference diffractive patterns, and compare the error to a reference; wherein, based on said comparison, the neural network is configured to determine phase control variables for the optical phase controller to compensate for the system drift and adjust the system output to near target; and wherein the neural network is configured to send the generated phase control variables to the optical phase controller, whereby the optical phase controller can use the generated phase control variables to stabilize the system against drift.

A method for stabilizing an optical beam combining system against drift, the optical beam combining system having a system input, a system output, an optical phase controller coupled to the system input, the optical phase controller having an input and an output, the method comprising: positioning a neural network positioned in a feedback loop between the controller input and the system output; training the neural network with multi-state dither information from the optical beam combining system; wherein after the neural network is trained, the neural network maps (i) a target and (ii) interference diffractive patterns measured from the optical beam combining system, to error in the measured interference diffractive patterns, and compares the error to a reference; wherein, based on said comparison, the neural network determines phase control variables for the optical phase controller to compensate for the system drift and adjust the system output to near target; and sending the generated phase control variables to the optical phase controller, whereby the optical phase controller can use the generated control variables to stabilize the system against drift.

As used herein, term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these group elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

Relational terms such as first and second, top and bottom, upper and lower, left and right, and the like may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to +0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential features or elements of the technology describes herein or any or all the claims.

In addition, in the foregoing disclosure various features may grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after that application is filed. Accordingly, the reader should consult the application as filed for the original content of the disclosure. Any deletion of content of the disclosure should not be construed as a disclaimer, forfeiture or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A machine-learning based stabilized beam combining apparatus, comprising:
an optical phase controller;
an optical beam combining system;
a neural network configured to be trained with multi-state dither information from the optical beam combining system;
wherein the neural network is configured to, after being trained with labelled data as said multi-state dither, map (i) a target and (ii) interference diffractive patterns measured from the optical beam combining system, to error in the interference diffractive patterns measured from the optical beam combining system, and compare the error to a reference;
wherein, based on said comparison, the neural network is configured to generate phase control variables as feedback on error correction for the optical phase controller to compensate for drift and noise in the optical beam combining system and adjust system output to near target; and
wherein the neural network is configured to send the generated phase control variables to the optical phase controller, whereby the optical phase controller can use the generated phase control variables to stabilize the optical beam combining system against drift and noise.

2. The apparatus of claim 1, wherein said apparatus allows training on a system not yet controlled and for continuous learning as the stabilizer operates.

3. The apparatus of claim 1, wherein said multi-state dither information is obtained differentially with a known action being input, the results of which are registered before and after, thus providing a multi-state in observation space, from which a trained neural network is capable of building the map between the differential observation space and controller action space, as opposed to conventional learning requiring observation of absolute value and action.

4. The apparatus of claim 1, wherein training with said multi-state dither information enables identification on a free-drifting many-in-many-out system, without a knowledge of a mathematical model.

5. The apparatus of claim 1, wherein the feedback is configured to feed the neural network, after training, a current measurement, which need not be contained in a training dataset, together with a desired pattern in the observation space, from which the neural network predicts the action needed to move apparatus output between these two states in a deterministic way.

6. The apparatus of claim 1, wherein said apparatus is capable of continuous learning while operating.

7. The apparatus of claim 1, wherein said apparatus automatically updates its training as conditions change whereby there is no need to retrain.

8. The apparatus of claim 1, wherein said apparatus does not require being stabilized during the multi-state dither information training process.

9. The apparatus of claim 1, wherein said apparatus, operating in an application subject to periodical non-uniqueness mapping, requires only a fraction of the training dataset near the operating point, instead of mapping the entire parameter space, toward obtaining rapid training speed on large scale systems.

10. The apparatus of claim 9, wherein said periodical non-uniqueness mapping comprises interferometric control on coherent beam combining.

11. An apparatus for stabilizing drift in a system, comprising:
a neural network that is trained with output signals from the system, wherein the trained neural network maps a target and output signals from the system to system error, compares the system error to a reference, and generates control variables for a controller coupled to the system to adjust system output to near target whereby the system is stabilized against drift.

12. The apparatus of claim 11, wherein said apparatus allows training on a system not yet controlled and for continuous learning as the stabilizer operates.

13. The apparatus of claim 11, wherein said apparatus is capable of continuous learning while operating.

14. The apparatus of claim 11, wherein said apparatus automatically updates its training as conditions change whereby there is no need to retrain.

15. The apparatus of claim 11, wherein said apparatus, operating in an application subject to periodical non-uniqueness mapping, requires only a fraction of the training dataset near the operating point, instead of mapping the entire parameter space, toward obtaining rapid training speed on large scale systems.

16. The apparatus of claim 15, wherein said periodical non-uniqueness mapping comprises interferometric control on coherent beam combining.

17. The apparatus of claim 11, further comprising:
an optical beam combining system;
wherein the neural network is configured to be trained with multi-state dither information from the optical beam combining system;
wherein the neural network is configured to, after being trained with labelled data as said multi-state dither, map (i) a target and (ii) interference diffractive patterns measured from the optical beam combining system, to error in the interference diffractive patterns measured from the optical beam combining system, and compare the error to a reference;
wherein, based on said comparison, the neural network is configured to generate phase control variables as feedback on error correction for the controller to compensate for drift and noise in the optical beam combining system and adjust system output to near target; and
wherein the neural network is configured to send the generated phase control variables to the controller, whereby the optical phase controller can use the generated phase control variables to stabilize the optical beam combining system against drift and noise.

18. The apparatus of claim 17, wherein said multi-state dither information is obtained differentially with a known action being input, the results of which are registered before and after, thus providing a multi-state in observation space, from which a trained neural network is capable of building the map between the differential observation space and controller action space, as opposed to conventional learning requiring observation of absolute value and action.

19. The apparatus of claim 17, wherein the feedback is configured to feed the neural network, after training, a current measurement, which need not be contained in a training dataset, together with a desired pattern in the observation space, from which the neural network predicts the action needed to move apparatus output between these two states in a deterministic way.

20. A machine-learning based apparatus for stabilizing drift in a system, the apparatus comprising:
a neural network configured to be trained with measured output signals from the system, the measured output signals including system drift;
wherein the neural network is configured to, after being trained, map the output signals and a target to system error and compare the system error to a reference;
wherein, based on said comparison, the neural network is configured to generate control variables for a controller to compensate for the system drift and adjust output signals from the system to near target; and
wherein the neural network is configured to send the generated control variables to the controller, whereby the controller can use the generated control variables to stabilize the system against drift.
